(19) United States
(12) Patent Application Publication
(10) Pub. No.: US 2012/0261848 A1
(43) Pub. Date: Oct. 18, 2012

(54) METHOD TO CREATE REMOVABLE DENTAL PROSTHESIS, AND THE DENTAL PROSTHESIS MAKING THEREOF

(76) Inventor: György Haraszati, Budapest (HU)

(21) Appl. No.: 13/519,031

(22) PCT Filed: Dec. 22, 2010
(86) PCT No.: PCT/HU2010/000150

§ 371 Date: Jun. 25, 2012

(30) Foreign Application Priority Data
Dec. 23, 2009 (HU) P0900804
Dec. 17, 2010 (HU) P1000675

(51) Int. Cl. A61C 13/20

(52) U.S. Cl. 264/17

(57) ABSTRACT

The subject of the invention is a method to create removable dental prosthesis, and the dental prosthesis making thereof, which solution is suitable for quick and efficient production of removable dental prostheses.

During the method according to the invention a digital data recording is made of the oral cavity without teeth, or with partial teeth-deficieny, or of the model taken of it, then the information received this way is processed by a computer with the help of a targeted software, and the virtual digital image of the removable tooth replacement (prosthesis) is created, and on basis of the virtual digital image of the prosthesis the finished product of the prosthesis itself, the base plate and the teeth are made with the help of a prototype making equipment of unique model-building,

Characteristic of one method according to the invention is that the prosthesis is produced from the established digital model with a spatial 3D printer (PRI) suitable for printing several different colors, several different raw materials from a thermoplastic raw material with a method based on melt layering, preferably with a Fused Deposition Modelling, (FDM) method.

Characteristic of one method according to the invention is that the prosthesis is produced from the established digital model with a spatial 3D printer (PRI) suitable for printing several different colors, several different raw materials from a biologically compatible liquid composite plastic material setting under laser or UV light, preferably with Multi Jet Modelling (MJM) method.

Further the invention is dental prosthesis, which is primarily made using the method according to the invention, preferably with melting (FDM) process using bearing material and raw materials of several colors applied layer by layer within a production process.

The subject of the invention is a method to create removable dental prosthesis, and the dental prosthesis making thereof, which solution is suitable for quick and efficient production of removable dental prostheses.

Nowadays in dentistry and in the area of prosthetic dentistry there is an ever growing demand for different dental appliances, prostheses to be put into the mouth. These prostheses can be either fixed or removable ones. It is always the individual characteristics of the patient that determine their production, concrete size and fitting, depending on the properties of the palate, gums, jaw and the maxillofacial area. Depending on the ratio of the teeth to be replaced, there are partial or full prostheses.

General requirements regarding prostheses:
good function
aesthetic
durable, mouth-fitting, biologically compatible

Furthermore the prosthesis must perfectly fit to the patient's mouth's individual properties, as the slightest problem of fitting can trigger unpleasant feelings of discomfort. It is especially valid for removable prostheses, where it is not enough to place the prosthesis into the mouth only once, but it has to fit in each single placing. Therefore making and precise fitting of removable prostheses is a complex task consisting of various steps.

There are different methods for making removable prostheses. According to the traditional method generally used nowadays making of a denture takes place in such a way, that the patient goes to see his dentist, where an anatomic mold is made, which is then sent to a dental technician, where a functional spoon is made, which is sent back to the dentist. Then the dentist makes a functional impression, and sends it back to the prosthodontics, where a mushbite is made, which is sent back again to the dentist. The dentist adjusts the bite heights on the pattern, and sends it back to the prosthodontics. The trial denture is made at the prosthodontics and artificial teeth are produced in a shellac baseplate in wax. They are sent back to the dentist, who tries them in the patient's mouth, and if everything is in order, then sends them back to the prosthodontics, where the final set of teeth is made, which also consists of artificial teeth, set in plastic baseplate. This method is very lengthy, because the patient can get their prosthesis after several days or weeks. Trying on several times, laborious fitting requires high level skills and supervision.

In the state of the art the EP 1062 916 patent description makes known process for manufacturing customized implant-mounted tooth replacements and process for making a dental prosthesis, especially of any, also biocompatible material and especially with the aid of the CAD-CAM method. The method involves applying a manipulation implant into a working model and then applying an auxiliary element which, together with the manipulation implant reproduces the position of the implant in the jaw. Using a scanner, the three-dimensional geometry of the working model and auxiliary element is detected Implant data defining the depth, inclination and relative position of the implant are determined from base data. Abutment data defining the connecting piece to be produced are determined from the implant data. The abutment is manufactured using a CAD/CAM system based on the abutment data.

The GB 2373 446 patent description makes known process for preparing a dental prosthesis. To prepare a dental prosthesis that has a shape exactly the same as in the form at the time of sound state, a process utilizing a CAD/CAM system includes subjecting three-dimensional coordinate information of an intra-oral shape, measured by impression taking or by photographing within an oral cavity of a patient, to three-dimensional graphic display on a graphic display device and designing a dental prosthesis on the three-dimensional graphic, wherein three-dimensional coordinate information of a previously preserved intra-oral shape of a patient at the time of sound state is subjected to graphic display simultaneously on the graphic display device; the dental prosthesis of an objective tooth is designed so as to have a shape same as the shape at the time of sound state; the obtained design data of the dental prosthesis is transmitted to a milling processor as a processing command; and a block material is subjected to milling processing to prepare a dental prosthesis.

The EP 1438 926 patent description makes known method and device of making a dental product, in particular a dental restoration. Job data represents a virtual restoration. In a processing center with a processing computer and a processing device there is a scanner that scans a generated dental product. Linked to the scanner's output, a comparing device compares its output data with the job data and works in a control device. Independent claims are also included for the following: (a) A device for building a dental product; (b) and for a method for using machine processing to produce dental products; (c) and for a device for processing dental products with a processing computer in a processing center.

The MX 2008 011 425 patent description makes known method for manufacturing digitally-designed removable dental prostheses and system required for this purpose. The system consists of a unit for scanning a mould obtained after the impression taken of a patient's mouth, an image transmitted to equipment for digitally generating a removable dental prosthesis, a file being obtained that is transmitted to equipment for manufacturing metal pieces by means of sintered powder, applying a high-energy ray. The design stages consist in relieving the mould, calculating the axis of insertion, parallelizing the teeth, designing the elements or components of the prosthesis, such as grids, hook, stops, major connector, minor connector, push-buttons, beads and lingual bar, extruding the various elements designed, smoothing the sharp edges, removing the superpositions of the different elements designed and converting to a closed surface that is continuous and connected in three dimensions.

For making certain teeth replacements furthermore is known the method with scanning and milling, which are for example used in systems marketed by 3Shape Dental System or Siemens. In the system called Sirona by the company Siemens the scanning and milling units are in the same equipment. The pattern of the teeth replacement should be placed into a clamping head in the equipment and it is scanned with a digital scanner. During making of the pattern the piece of pattern is made from a block of proper size and material by milling. The drawback of the method is, that it is suitable for making patterns of smaller size only, and it results in considerable loss of raw material due to milling

In the state of the art three dimensional printers for making different objects, patterns are more and more developed. They are able to realize the objects in space on basis of a digital plan created preliminarily. The main types of such 3D printers are as follows:

Z Corporation produces such a machine that mixes up a powder and an adhesive liquid, and builds up the pattern layer by layer. The adhesive liquid is colored, otherwise the powder is white. Everything is built up from this. The device marketed by Enge CAD Cam Systems builds up the object from layerfilms. In case of other 3D printers, for example in the system of Bego Medical Company, the pattern is made from metal powder, melted with laser and the device builds up the pattern this way layer by layer.

Furthermore such 3D printers are known, that build up the pattern with photopolymerization from liquid plastic layer by layer. Such 3D printers are from Envision TEC and OBJET companies. During making the pattern the liquid plastic is lit by UV light, so it sets, creating a piece of the pattern. The whole pattern is built this way on basis of the digital plan. Making of the pattern is similar to two-dimensional inkjet printers still widely used, only printing takes place in three dimensions. Coloring of the pattern takes place with coloring material added to the liquid plastic.

The WO 0180761 patent description makes known interactive orthodontic care system based on intra-oral scanning of teeth. Interactive, computer based orthodontist treatment planning, appliance design and appliance manufacturing is described. A scanner is described which acquires images of the dentition which are converted to three-dimensional frames of data. The data from the several frames are registered to each other to provide a complete three-dimensional virtual model of the dentition. Individual tooth objects are obtained from the virtual model. A computer-interactive software program provides for treatment planning, diagnosis and appliance from the virtual tooth models. A desired occlusion for the patient is obtained from the treatment planning software. The virtual model of the desired occlusion and the virtual model of the original dentition provide a base of information for custom manufacture of an orthodontic appliance. A variety of possible appliance and appliance manufacturing systems are contemplated, including customized archwires and customized devices for placement of off-the shelf brackets on the archwires, and removable orthodontic appliances.

The WO 2006 031 096 patent description makes known method of manufacturing and installing a ceramic dental implant with an aesthetic implant abutment. Manufacturing of tooth prosthesis, for insertion in a jawbone, comprising an implant and an abutment on top of the implant. The method comprises: defining a shape of the prosthesis and its location in the jawbone by using first data from a first CT scan image of the jawbone and second data from a second image of a gypsum cast, correlating first and second data by extracting from the first data first position reference data of a first reference in the first image, and from the second data second position reference data of a second reference in the second image, the second reference being identical to the first reference; performing a geometric transformation on the second data and/or the first data to have a coincidence of the second image with the first image and to combine the first and second data into composite scan data.

The WO 2007 010 524 patent description makes known method for manipulating a dental virtual model and for creating physical entities based on a dental virtual model thus manipulated, and dental models thus created. A 3D virtual model of an intra oral cavity in which at least a part of a finish line of a preparation is obscured is manipulated in virtual space by means of a computer or the like to create, recreate or reconstruct finish line data and other geometrical corresponding to the obscured part. Trimmed virtual models, and trimmed physical models, can then be created utilizing data thus created. The virtual models and/or the physical models may be used in the design and manufacture of copings or of prostheses.

The WO 2008 005 432 patent description makes known system and method for manufacturing full and partial dentures. There is provided a system for fabricating at least a portion of a denture. The system includes a three-dimensional scanning device for scanning a surface of a denture template, and a computer-readable medium including a computer program for receiving data from the scanning device, creating a 3-dimensional model of the surface, and optionally modifying the 3-dimensional model and/or adding features to the 3-dimensional model. The system also includes a fabricator for creating the at least the portion of the denture, from a selected material, based on the 3-dimensional model. The fabricator may be a device including a lathe, or a rapid prototyping machine. There is also provided a method for fabricating at least a portion of a denture.

From the second half of the 80s such state of the art three-dimensional (spatial) quick prototype (Rapid Prototype) production methods have been developed, with the help of which products built up layer by layer with novel material adding could be produced with the so called 3D printers. It is able to form body models produced by CAD systems into plastic (and/or metal) spare parts, according to different methods. In order to be able to produce a “finished product” from a 3D model, the slicing (disassembly) of the 3D model is necessary. It is made by the own programs of 3D printers with an input of a special format STL file. The surface of the body model is mapped with the help of triangles. Each apex (x;y;z) of the triangle contains spatial digital information. An STL file can be of two types, binary or text ASCII format, which in both cases is a list about the describing triangles.

The quick prototype production, contrary to the traditional disassembly technology, produces the required shape by adding material layer by layer—in an additive way. The RPT technologies can be grouped on basis of the raw material used, respectively the technology used for processing as follows:

Liquid raw material;
typically polymer which can form to spatial netted structure which sets under laser or UV light. “SLA”-laser stereolitography, as well as the socalled “PolyJet” method, which is basically a 3D “inkjet” printing with a liquid polymer are typical methods.

Powder raw material;
melting of adjacent particles by laser, “SLS” technology, possibly unification with a kind of adhesive material “3D Printing”. (polymer, resp. metal dust+composite of polymer).

Solid raw material;
“LOM” technology is well-known (cutting and building layer by layer). Here the outlines are cut from the film coated with adhesive on one side by laser light, then after stepping further, the adhesion is fixed by heat of a heated cylinder, but the table sinks lower before.
The other type is a method based on “FDM” making layers of the melt, where generally melting of polymers of wire shape as a following layer onto the designated pixels occurs. The technology works only with polymers of crystallic structure, namely this PE copolymer, or PP polymer ensures the difference of 2-3° C. between melting point and setting. Placing is made by an extruder-head controlled by CAD/CAM in a thermally stabilized working space.

It is common in the above methods, that a part of the raw material of given quantity was hardened, separated from the quantity left. The retained material can be usually recycled.

In case of (Fused Deposition Modelling, FDM) method based on melt layering, a prototype is made in such a way, that the prototype of precise size is made by building the melted material placed in a concrete way. Theoretically this method is suitable for direct 3D forming, but it can be operated in 2D function as well.

The drawback of the known methods of producing prostheses is that they only solve a partial procedure of the planning, respectively producing of the prosthesis, not making possible automated production and forming of prostheses in a rapid and customized way.

In the state of the art until now solutions the oral cavity of the patient is mapped or scanned with a known method, and transformed into digital data. The digital virtual image, model of the oral cavity is created from these data. The digital design of the dental appliance, the prosthesis takes place in this digital model. A database is created from this digital design, necessary for spatial printing.

When working out the solution according to the invention we aimed to create a rapid and efficient method for producing removable dental prostheses, with the help of which individual protheses of suitable mechanical strength, conforming with unique, special anatomical form and color requirements can be produced quickly in great numbers, without involving significant professional expertize.

When creating the solution according to the invention, we realized, that in case a digital data recording can be made of the oral cavity or the mold taken of it, without teeth, or with with partial teeth-deficieny, with the help of a scanner, then the information received from the scanner is processed in a computer with the help of a targeted software, and the virtual digital image of the removable (prosthesis) is made, then with the help of an equipment, making unique pattern, prototypes, preferably with a 3D printer, the finished product of the prosthesis, the baseplate and the teeth are made preferably from materials of different, anatomically appropriate colors, or from properly colored materials, then the set aim can be achieved.

Moreover we realized, that in case the prosthesis created from the digital model in the known way, was made by a spatial printer suitable for printing various colors and various raw materials, with a method based on melt layering of a thermoplastic material, preferably by Fused Deposition Modelling, (FDM), or Multi Jet Modelling (MJM), then as an end result a plastic prosthesis is made with suitable mechanical and biological properties, the coloring and anatomical shape of the prosthesis fully conforms with the teeth found in a normal oral cavity, and fits perfectly to the appropriate parts of the oral cavity.

The invention is a method to create removable dental prosthesis, during which a digital data recording is made of the oral cavity without teeth, or with partial teeth-deficieny, or of the model taken of it, then the information received this way is processed by a computer with the help of a targeted software, and the virtual digital image of the removable tooth replacement (prosthesis) is created, and on basis of the virtual digital image of the prosthesis the finished product of the prosthesis itself, the base plate and the teeth are made with the help of a prototype making equipment of unique model-building. The method is characterized by that, the prosthesis is produced from the established digital model with a spatial 3D printer (PRI) suitable for printing several different colors, several different raw materials from a thermoplastic raw material with a method based on melt layering, preferably with a Fused Deposition Modelling, (FDM) method.

Further the invention is a method to create removable dental prosthesis, during which a digital data recording is made of the oral cavity without teeth, or with partial teeth-deficieny, or of the model taken of it, then the information received this way is processed by a computer with the help of a targeted software, and the virtual digital image of the removable tooth replacement (prosthesis) is created, and on basis of the virtual digital image of the prosthesis the finished product of the prosthesis itself, the base plate and the teeth are made with the help of a prototype making equipment of unique model-building. The method is characterized by that, the prosthesis is produced from the established digital model with a spatial 3D printer (PRI) suitable for printing several different colors, several different raw materials from a biologically compatible liquid composite plastic material setting under laser or UV light, preferably with Multi Jet Modelling (MJM) method.

In one preferred possible application of the method according to the invention the material used during the making of the prosthesis (PRO) is a biologically compatible, liquid composite, setting under light, typically plastic polymer which can form to spatial netted structure setting under laser or UV light.

In another preferred possible application of the method according to the invention digital data recording takes place either directly from the mouth in the oral cavity, or from a mold made of the mouth, respectively from the model made on basis of the mold, with applying 3D scanner.

In a further preferred possible application of the method according to the invention the digital data recording takes place either on basis of a 3D CT X-ray, or a 3D X-ray, or on basis of an MRI recording.

In a further preferred possible application of the method according to the invention following the digital data recording certain additional information is acquired regarding the position (articulation) of the mandible (mandibula) respectively the upper jaw (maxilla) and the virtual digital image of the removable teeth replacement (prosthesis) is corrected by these data.

In a further preferred possible application of the method according to the invention during the method the steps of the task to be realized are the following:
Receiving X-ray recording made by an external device (3D Scanner, 3D CT, MRI),
Conversion of database received this way into proper format (optional),
Disassembly input data into layers, separating of “materials” of different types,
Creating automatic mucous membrane on basis of input materials,
Saving body model consisting of several layers for further use,
Visualizing layers as a 3D model,
Editing certain parts of the model, executing different modifications on basis of parameters determined later,
Making layer by layer STL database from the body model prepared this way,
Sending STL database made to the printer,
Continuous communication with the printer (handling mistakes)
Installing copy protection function, joining the hardware of the printer.

In a further preferred possible application of the method according to the invention the temperature of the work space of the 3D printer used in the method, can be regulated and stabilized.

In a further preferred possible application of the method according to the invention reading of STL files into the device and preparing spatial printing take place with the production control software of 3D printer, with the help of “Software 3” program package.

In a further preferred possible application of the method according to the invention the definite operation of the 3D printer applied during the method, its hardware elements, for example head warming, material feeding, bench moving, fibre feeding, syncronous motors, as well as the regulation of the several heads are controlled by a target software, in given case “Software 4” designated for this purpose.

In a further preferred possible application of the method according to the invention the 3D printer applied uses a bearing material, and biocompatible raw material of two or three or four color, and the 3D printer builds up the teeth from a white, toothlike color material, the base plate is made from a unicolor pink material (gingiva).

In a further preferred possible application of the method according to the invention the 3D printer (PRI) operating on melting principle (FDM) includes a head unit suitable for feeding four different materials.

In a further preferred possible application of the method according to the invention the head unit applied during the method comprises two adjacent double heads (4) moving independently from each other, but synchronized with each other, which are heated FDM heads (4) functioning on mini-extruder principle, and the moving of high-speed 3D is controlled by a CAD/CAM program.

In a further preferred possible application of the method according to the invention in case a partially removable denture is made, then retention is provided with a gum-clamp or tooth-clamp by the program, which must be designed by such a program for this purpose, that is capable of making gum-clamp and tooth-clamp.

In a further preferred possible application of the method according to the invention a complete prosthesis, a lower and upper denture fitting to each other is made.

In a further preferred possible application of the method according to the invention the application of the method takes place on a local level, in given case with the participation of a dental expert, using a 3D scanner, a computer (PC), and a 3D printer.

In a further preferred possible application of the method according to the invention the application of certain steps of the method takes place on different locations, and for the application of the first step scanners and/or CT terminals are installed on different spots, the data of which are sent to a central place, to a central computer, where designing of the prosthesis (PRO) with the targeted software as the second step occurs, and as a third step, the production takes place on the same spot, from where in given case delivery takes place with a mail delivery service or a courier.

In a further preferred possible application of the method according to the invention the patients themselves make the prosthesis, respectively with the help of a mouth scanner they themselves take the mold.

Further the invention is dental prosthesis, which is characterized by that, it is primarily made, using the method according to the invention.

In one preferred realization of the dental prosthesis according to the invention the prosthesis is made with melting process using bearing material and raw materials of several colors applied layer by layer within a production process.

The solution according to the invention is set forth with the help of the enclosed figures as follows.

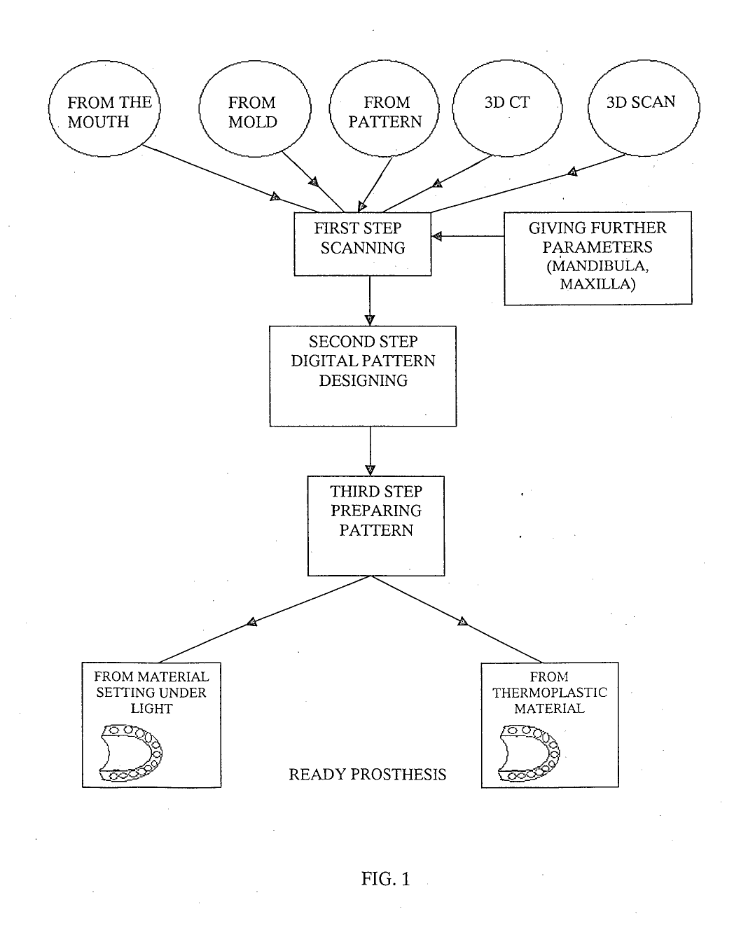

The FIG. 1 shows the general steps of the designing method used for the method for producing the prosthesis according to the invention.

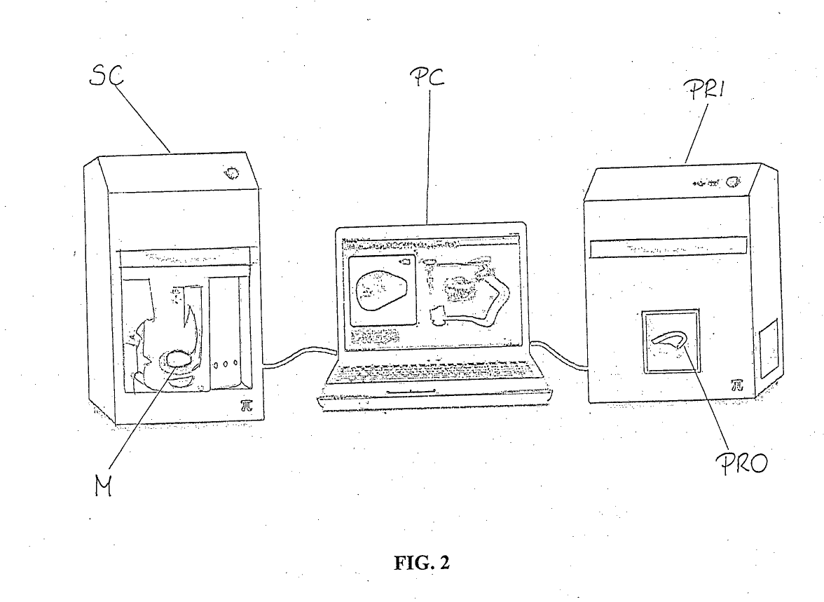

The FIG. 2 shows possible, preferable concrete devices and their connection with each other in general case of the realization of the method according to the invention.

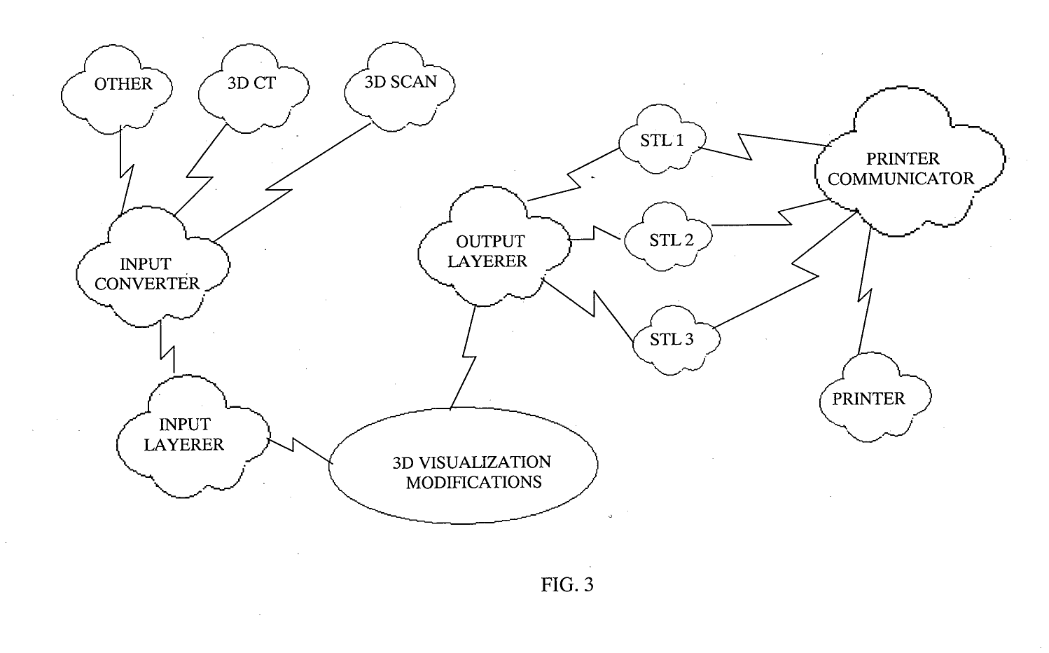

The FIG. 3 shows general aspects and elements of the system of prosthesis designing method applied during the method according to the invention.

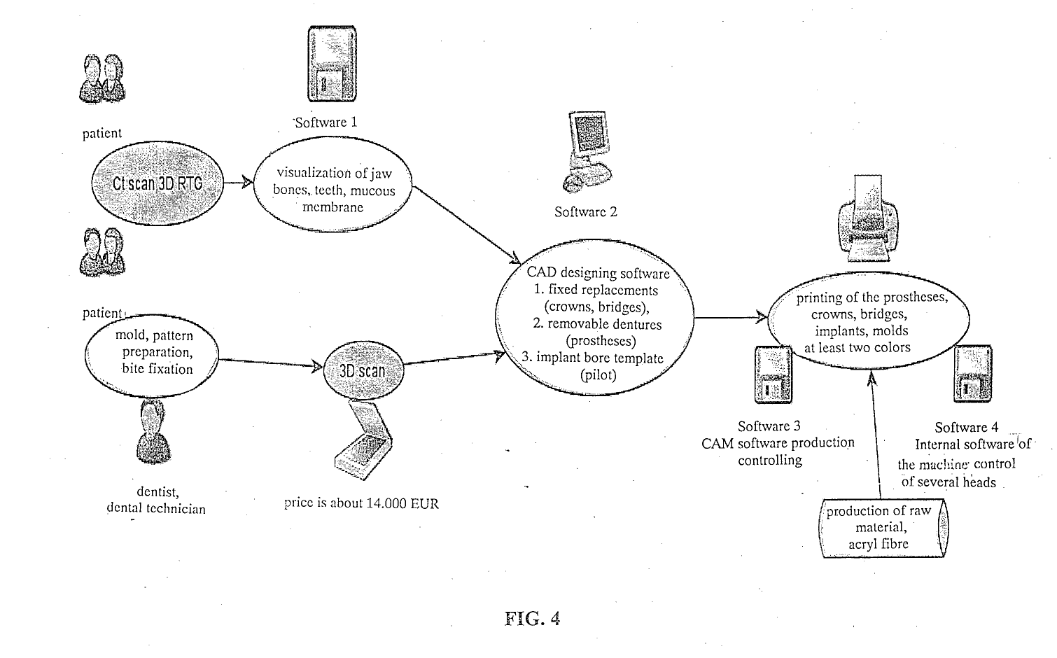

The FIG. 4 shows the steps of the designing method applied during the method according to the invention in case of a preferable concrete realization.

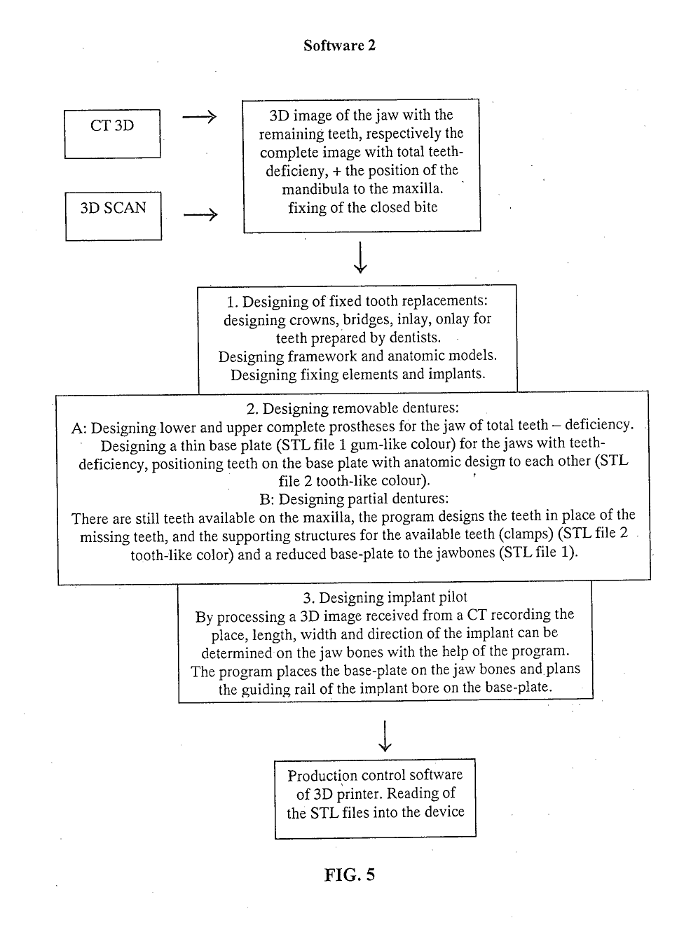

The FIG. 5 shows the main steps of CAD designing software “Software 2”.

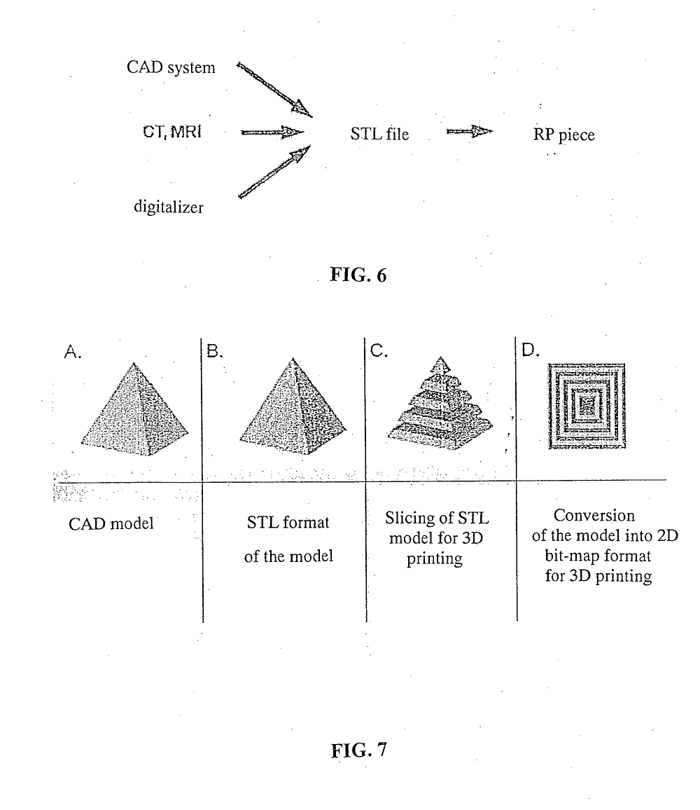

The FIG. 6 shows the designing conditions of the input side software in case of several different input data sources.

The FIG. 7 shows the process of digital preparation of 3D printing in case of the printing method used during the method.

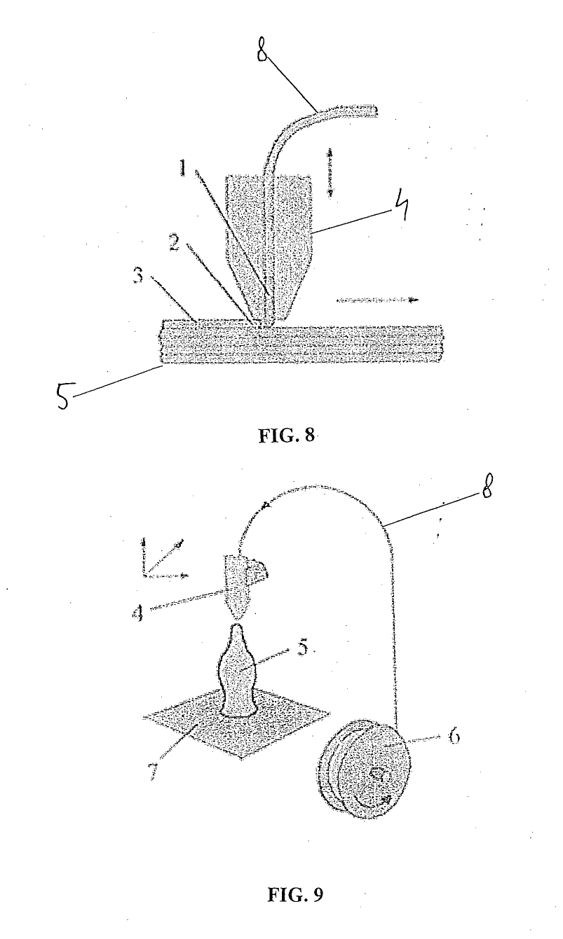

The FIG. 8 shows the principle of the spatial printing process operating on basis of melt layering (Fused Deposition Modelling, FDM) used during the method.

The FIG. 9 shows the head arrangement and the way of feeding of the raw material of the spatial printing operating on basis of melt layering (Fused Deposition Modelling, FDM).

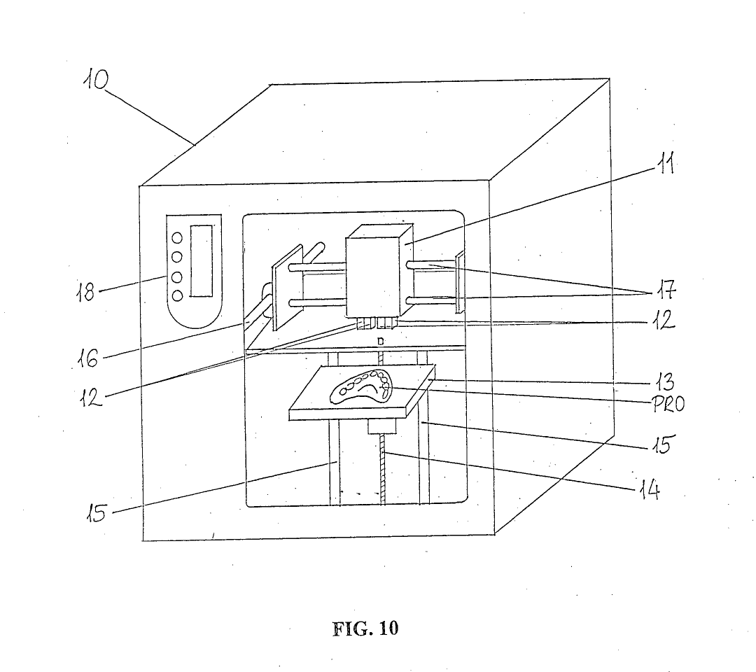

The FIG. 10 shows the general parts of the basic structure of the spatial printing equipment operating on basis of melt layering (FDM).

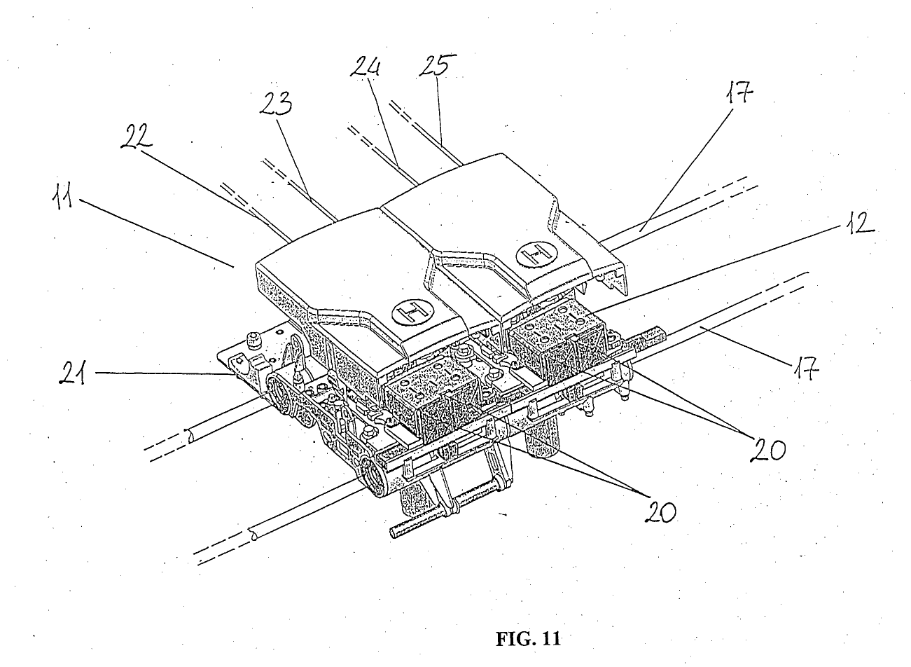

The FIG. 11 shows a possible preferable realization of the head unit 11 making spatial printing in case of a finish suitable for printing different colors.

The FIG. 1 shows the general steps of the designing method used for the method for producing the prosthesis according to the invention.

As a first step a digital data recording is made of the oral cavity without teeth, or with partial teeth-deficieny. It is possible to make a digital data recording with scanning directly from the mouth in the oral cavity, or from a mold made of the mouth, respectively of a model, pattern made on basis of the mold. Moreover a digital data recording is also possible with 3D CT, respectively 3D SCAN method. Following the digital recording in given case certain additional information is acquired regarding the position (articulation) of the mandible (mandibula) respectively the upper jaw (maxilla) of the patient.

As a second step the information is processed on the computer with a software and the virtual digital image of the removable dentures (prostheses) is modelled.

As a third step on basis of the virtual digital image of the prosthesis, the finished product of the prosthesis is made with the help of a 3D printer. The baseplate and the teeth are preferably made of materials of different colors. The making of the prototype is possible with applying the known technologies from thermoplastic materials, or from materials setting under light.

In case a complete prosthesis is made, then the lower and upper prosthesis are designed within a designing process, and printed by a 3D printer at the same time, or following each other. During the designing process of the prosthesis the individual anatomical properties are taken into consideration, and the lower and upper parts of the prosthesis are designed accordingly, fitting to each other.

The FIG. 2 shows possible, preferable concrete devices and their connection with each other in general case of the realization of the method according to the invention.

It can be seen in the figure, that in case of the realization of the method in given case a SC 3D scanner joining a PC computer, in given case a laptop, is used. A PRI 3D printer also joins the PC computer.

In given case the data of M model put into the SC 3D scanner are digitally recorded. The data are forwarded to the PC computer, where additional parameters, in given case anatomical data are added, respectively corrected. On basis of this the PC computer makes the digital design of the PRO prosthesis. It is printed by the PRI 3D printer. At the end of the process the readymade product of the PRO prosthesis is available.

The FIG. 3 shows general aspects and elements of the system of prosthesis designing method applied during the method according to the invention.

In case of a possible preferable realization of the method according to the invention the production of the removable prosthesis by rapid prototype method takes place in the following steps on basis of the conditions below.

In case of this possible preferable realization of the method according to the invention the primary task is to compile such a CAD/CAM system, which can visualize in a 3D way images of 3D base recordings from several input sources. By determining the parameters the visualized body modell is made suitable for editing. The determination of the parameters takes place on basis of dental and anatomical knowledge. The parameters can greatly influence the model to be edited. The model edited this way gets to the printer on basis of the communication used during the method.

The steps of the task to be carried out during the procedure are as follows:
Receiving X-ray recording made by an external device (3D CT, 3D Scanner, MRI),
Conversion of database received this way into proper format (optional),
Disassembly input data into layers, separating “materials” of different types
Creating automatic mucous membrane on basis of input materials,
Saving body modell consisting of several layers for further use,
Visualizing layers as 3D model,
Editing certain parts of the model, executing different modifications on basis of parameters to be determined later
Making layer by layer STL database from the body model prepared this way
Sending prepared STL database to the printer,
Continuous communication with the printer (handling mistakes)
Installing copy protection function, joining the hardware of the printer

During the method according to the invention primarily the above partial tasks are to be executed and realized. The system is built up in a module form for the sake of the possibility of further easier extension.

The FIG. 3 furthermore shows the structure of the system, the process of operation, which is the following:

The system comprises devices that can operate as input, respectively output devices as well. In the present case we have three different input devices, in the left top of the figure, respectively an output device, the printer itself, on the bottom right in the figure. Modules themselves can be seen in the figure, which belong to the great program of circle form. These modules carry out certain functions.

The system includes external input devices, in given case 3D CT or 3D Scanner, or MRI, with the help of which an X-ray recording is received by a receiving module, functioning at the same time as a converter. This input converter module executes the necessary conversions for the subsequent processing procedure. In the initial phase the format, respectively processability of the input database is very important.

In given case the output is only an image (for example: jpg), serving actually only the visualization, eg. the dentist could examine the patient. In this case processing of this image is not possible, respectively much more difficult and incorrect. As the input database can come from several sources, a common receiving module has to be formed, executing the necessary conversions for the next processing procedure, and to which a concrete input can be joined.

Depending on the format of the database, data processing is possible in two different ways. The possible input datasources are:
image based (X-ray, or CT)
3D model based (3D scanner, 3D CT)

In case of image based format, the possibility of separation of certain layers means a serious problem. So it could be a serious obstacle, that during the separation (as an image must be processed, and there are no “sharp” outlines), considerable incorrectness can be expected. Obviously it can be corrected later in a manual way, but it will never be perfect. In case of a 3D model the same problem can be experienced, but there we are a big step closer to the layers to be visualized, as there we theoretically get a processed database reflecting the present state in 3 dimensions and even in several layers.

Automatic layering can be carried out on basis of this. The parts automatically layered must be capable of being manually altered, as the machine will definitely not be able to determine it exactly. Naturally the system can be formed in such a way, that it learns certain processes itself in the future. The learning process can be automatically influenced as well, as the more data the system processes and observes the manual modification followed, the better the accuracy of automatization can be taught. Therefore it is necessary to acquire several inputs to teach the software with their help. Obviously programming of the teaching process is a difficult task in itself as well.

If the certain layers are available, then the 3 dimensional body model can be visualized from them. It is possible to influence the visualization of each layer. It means that the software will deal with the bones, the mucous membranes, certain treatments, etc. as separate layers, or as a unit. Ultimately it produces single objects, the visualization of which can be influenced. Naturally each of such objects is in connection with each other, as the corresponding other object should be altered during the modification. The best example for this is an operation with a definite tooth, eg. tilting. Here the location in the gums must be altered as well.

The most complicated part of the process is the possibility of modification. The system must automatically create the enclosing form on basis of the mucous membrane. It must be modifiable on basis of the given dental parameters. To this each tooth has its three dimensional model, scanned digitally. These teeth should be automatically placed on the chosen mucous membrane. Obviously only to those places, where there is a gap. Later these replacements should be in given case modified on basis of the given parameters.

In case of a preferable, concrete realization, the following actions can be made on the digital model (obviously the actions can not be made with the original teeth):
Placing a new tooth
Removing a replacement
Reducing in size/enlargement
Rotating
Tilting
Taking out of its place

The software must carry out furthermore such actions that are executed during a concrete physical operation by the dentist. Accordingly the following operations must be simulated and handled:
Adding to the tooth that is to extend the surface to a certain direction. It raises at once several questions, whether how this kind of operation can be executed, as in reality the material to be put on the tooth is of amorph form. Whereas in computer simulation it is much easier and more comfortable to build according to a given form. Here the possible variants must be determined. Actually all the forms can be fed back to the basic form, with which the operation can be carried out.
To remove something from the tooth by polishing. It actually means that the extension is decreased by a certain form, by a certain part of the space. Here this form should be determined, which is a circle in basic case. However it could be an issue of convenience to work with other shapes as well.

The conditions of the new set of teeth created this way should be forwarded to the output converter modifying the data to the necessary format. This case it means the generation of the STL database. As the STL format itself can not handle either color or material information, therefore conversion is executed in such a way, that the certain layers (this case it is about two layers) are generated into separate databases.

The databases generated this way—conforming to the standard STL format—can be sent to the communication module, realizing the communication with the printer. The size of memory is important in the communication sector. Handling of a database of more than 10 MB can be expected, therefore it is important to ensure, that the machine is able to receive it. If the machine is not suitable for this, then this communication sector should be able to slice “to a certain extent”, as it is possible to decide on basis of these data (only), which part of the design could be sent to the printer.

The FIG. 4 shows the steps of the designing method applied during the method according to the invention in case of a preferable concrete realization.

It can be seen in the figure, that the digital datarecording of the patient is done basically in two ways. One of the ways is the traditional one, during which the fixing of the bite is taken with the intermediary of a dentist, or dental technician, then on basis of this the impression and the model are made. The model made this way is scanned by a 3D scanner and a digital data package conforming to the model, the digital impression is produced.

According to the other method a recording is made of the patient's cavity by 3D scanning, or 3D X-ray, which is converted respectively corrected into a digital package suitable for processing for the design with the help of “Software 1” dataprocessing software package. During this phase visualization of the jaw bones, teeth, as well as the mucous membrane and fixing of the bite takes place. This way the characteristic digital impression of the patient's mouth is created.

The digital impression created according to the above is processed by the dataprocessing software package “Software 2”, with a CAD designing software, and the digitally designed denture, prosthesis is created. During designing fixed replacements (crowns, bridges), removable replacements (prostheses) as well as implant bore templates (pilots) can be produced.

The prosthesis digitally designed comes to production preparation with the help of “Software 3” CAM program package controlling production and direction. During this process “Software 3” makes such a design of the model, that includes the optimal way of locating the object to be printed, and calculates the bearing material and printing parameters.

The printing of the prostheses, crowns, bridges, implants, molds by a PRI 3D printer applying at least two more colors beside the bearing material follows. During printing the internal software of the machine, “Software 4” program controls the definite function of the machine, its hardware elements, such as head warming, material feeding, table movements, fiber feeding, synchronized motors and control of several heads. Producing raw material fibres conforming with several colors from a thermoplastic material, in given case from an acrylic belongs also to printing.

Data processing software package “Software 1” to be seen in the FIG. 4 converts, respectively corrects the data recorded by CT SCAN, 3D X-ray for the designing process. This program should conform with the conditions and requirements below. It must be made possible, that 3D digital impression conforming with the patient's model can be acquired and created from the CT image. The biggest problem is, that it is not possible to acquire from the dental “cone beam” CTs the original 16 bit projections, respectively the 3D slices made in the CT. What can be acquired is a standard 8 bit jpg file export in DICOM format, CT software programs generally support this. You can find out that the original images are 13-16 bit, when some of the software programs offer the correct bone-density value on the screen to the dentist. These files are however provided with the producer's own code, or are in an encrypted form.

The other problem is, that the slices are made with a rapid algorythm, which is however of an inferior quality. Today it would be possible to make more precise and nicer slices from the original projections with a slower process.

If such a software is made by ourselves, then first the producer's own format must be found out, or the code must be acquired to make further procession of the data possible.

The next phase is the normalization of the slices (setting identical brightness and contrast values) and segmentation, the calculation of the limit value, above which the 3D surface should be seen. Then comes the walking cube algorythm, which either adds 3D pixels from the voxel cloud to the body to be visualized, or leaves them. Afterwords the lighting and projecting model comes, including ambient light and spot lightsource, as well as viewpoint and Z covering algorythm. It is to be noted, that a voxel cloud can be also visualized, there are a few simple solutions, but the automatic dental designing software is more difficult to be based on the result. Optional convenience functions are segmentation (showing more—or less tissues in the image) and the possibility of perpetual revision, in-render (real-time) setting of the viewpoint (rotation in space). The trials for the separation of different tissues, (bone, inter-osseous diploe, bonebridges, saburra, air, tooth, nerve, muscle, mucous membrane etc.) for the application of the method according to the invention for prosthetic dentistry can be founded subsequently. Here we do not speak about geometrical analysis of head, set of teeth and bite, only about the structural interpretation of the voxel mass from the point of view of visualization. Other similar software programs are available for that purpose.

Regarding software architecture, a solution with hardware support is recommended (eg. OpenGL), and it is worth using those free or cheap packages, that can offer API for the 3D function.

The FIG. 5 shows the main steps of CAD designing software “Software 2”. The input data of the software are the data received during scanning the oral cavity with CT 3D or 3D SCAN. The 3D image of the jaw with the remaining teeth, respectively the image with total teeth-deficieny,+the position of the mandible to the maxilla, as well as the fixing of the closed bite will be determined

Three different possible designing processes follow.

### 1.Designing of Fixed Tooth Replacements: Designing Crowns, Bridges, Inlay, Onlay for Teeth Prepared by Dentists.

Designing framework and anatomic models.

Designing fixing elements and implants.

### 2. Designing Removable Dentures:

A: Designing lower and upper complete prostheses on the jaw of total missing teeth. Designing a thin base plate (STL file 1 gum-like color) for the jaws without teeth, positioning teeth on the base plate with anatomic design to each other (STL file 2 tooth-like color).

### B: Designing Partial Dentures:

There are still teeth available on the jaws, the program designs the teeth in place of the missing teeth, and the supporting structures for the available teeth (clamps) STL file 2 tooth-like color) and a base-plate reduced to the jawbones (STL file 1).

### 3. Designing Implant Pilot

By processing a 3D image received from a CT recording the place, length, width and direction of the implant can be determined on the jaw bones with the help of the program.

The program places the base-plate on the jaw bones and plans the guiding rail of the implant bore on the base-plate.

Following the above planning, the reading of the STL files into the device and preparation of the spatial printing take place with the help of “Software 3” program package, the production control software of 3D printer.

The FIG. 6 shows the designing conditions of the input side software in case of several different input data sources.

In case of several different data sources, eg. CAD system, CT, MRI, Digitalizer data are received in different formats, so they should be unified for further planning The STL file is the most beneficial data format for the further data processing, and CAD designing, so files of different formats should be converted to such a format. Making RP rapid prototype occurs on basis of STL files.

The FIG. 7 shows the process of digital preparation of 3D printing in case of the printing method used during the method. The four phases of digital preparation can be seen in the figure as follows:
A: CAD model
B: STL format of the model
C: Slicing of STL model for 3D printing
D: Conversion of the model into 2D bit-map format for 3D printing

On the input side the complete prosthesis body model “to be printed” is created either by digitalization, for example from 3D scanning, or by using any of the CAD systems, respectively with CT or MRI application.

In order to create the “end product” from the 3D model, it is necessary to configure, slice (disassembly) the 3D model in virtual space (visualizing on PC), executed by a special software. The same software renders an optimized spatial support to the prosthesis designed digitally, which is removed with the help of a water solution after printing. The input of the program executing configuration is an STL file of special format.

The surface of the body model is scanned with the help of triangles by the applied program, in given case by the “Software 3” program package. Each apex (x;y;z) of the triangles contains spatial digital information. The STL file can be of two types, binary or text ASCII format, which in both cases is a list about the describing triangles.

The program carries out change of measure units, change of scale, as well as arrangement of optimum, and forwards the file processed this way toward the printer, which maps the 3D model with the help of the executing elements in the heated bench, layer by layer (according to disassembly, that can be set).

The communication software of the control unit—with the help of the applied program, in given case “Software 4” program package—directs the heating of stepping motors, heating ventillators, injectors, as well as the function of the feed servomotor, putting the melted polymer on the given spatial pixel spots, with appropriate speed. The same program looks after the measuring of the bench, resp. designation, as well as the necessary prohibiting and regulating functions.

The FIG. 8 shows the principle of the spatial printing process operating on basis of melt layering (Fused Deposition Modelling, FDM) used during the method.

The FIG. 9 shows the head arrangement and the way of feeding of the raw material of the spatial printing operating on basis of melt layering (Fused Deposition Modelling, FDM).

As it was made known in the state of the art, in case of melt layering (FDM) method, the prototype is made in such a way, that the melted material is placed on designated spots and the prototype of accurate size is produced this way. This method is theoratically suitable for direct 3D formation as well, but it can work in 2D function too.

The principle of melt layering (FDM) can be seen in the FIGS. 8 and 9, the raw material 8 in melted 1 form , the start of setting 2, the set state 3, the heated FDM head 4, the model 5, the feed drum 6, as well as the moving bench 7.

The key equipment is the heated head 4 with mini-extruder function, where the moving of high-speed 3D is controlled by a CAD/CAM program. Heating heats melt 1 just above a temperature of melting point Tₘ, generally no cooling is needed. In given case a layer thickness of 0.025-1.25 mm can be realized with a thermoplastic fiber of 1.25 mm diameter used as raw material 8. The equipment ensures an accuracy (tolerance) of 0.125 mm with the melt 1 jet moving with a speed of 380 mm/s The equipment assembled this way is suitable for producing a prototype of max. 300×300×300 mm size.

The FIG. 10 shows the general parts of the basic structure of the spatial printing equipment operating on basis of melt layering (FDM).

The figure shows the 3D printer 10 working on (FDM) principle of melt layering, having a multifunctional head unit 11 containing four printing heads 12. The bench 13 is located under the head unit 11, used for making the given prosthesis PRO as a model, in given case with the application of melt layering process. Under the bench 13 the elevating spindle 14 moving the bench 13 up and down in vertical direction, as well as the vertical guide rails 15 belonging to the bench 13 doing the driving of the moving of the bench 13 can be found.

In the inside of 3D printer 10 can be furthermore found the horizontal guide rails 17 driving the head unit 11 in horizontal direction lateral right-left, as well as the horizontal guide rail 16 driving the head unit 11 lateral forward-backward. Outside the house of the 3D printer 10 is placed the operating and control panel 18 adjusting and displaying the operational parameters.

During the operation of the 3D printer 10 the head unit 11 moves on basis of the control program into three directions according to the model of the prosthesis PRO to be made, and the prosthesis PRO model is built up with the (FDM) melt layering method with the printing heads 12 in the head unit 11 from the bearing material and raw materials of various colors.

The FIG. 11 shows a possible preferable realization of the head unit 11 making spatial printing in case of a finish suitable for printing different colors. The figure shows the multifunctional head unit 11 operating on the principle of melt layering (FDM), containing four printing heads 12, which are placed next to each other on a support panel 21. The support panel 21 is placed on the horizontal guide rail 17 ensuring the lateral guide and moving. The discharge openings 20 of the printing heads 12 can be seen in the figure, through which the melt material conforming with the prosthesis PRO model leaves the printing head 12. As it can be seen in the figure, each printing head 12 is joined by a raw material fibre, a fibre for bearing material 22, a raw material 23 for the prosthesis PRO base plate, a raw material 24 for the tooth color 1, eg. for the tooth neck, and a raw material 25 for the tooth color 2, eg. for the tooth edge.

In case of a preferable concrete application of the method according to the invention the printer applied is a modified version of a printer operating with melt layering (FDM) technology. The fundamental difference compared to all the 3D spatial printers in use is, that the printer applied here is capable to function not with only one, but with three different materials, respectively with materials of different colors, beside the one bearing material (needed in any case) due to its construction. This task can be solved by the machine in such a way, that the socalled Duplex-holder moving in X-Y plane works not with only one, but two printing heads moving in synchron with each other, respectively alternating, in such a way, that the STL file of the model to be produced can distinguish the pixels on each layer belonging to different material qualities, and controls the switching on and off the printing head belonging to it. Going over the single layers is made by the bench controlled by the stepping motor working with 0.254 mm elevation (optionally 0.175 mm) on a vertical (Z axel) direction. Choosing of the required operation can be adjusted by the keyboard, or in the menu of the built-in touch-screen PC, or the starting of the tests running of calibration-checking.

The conditions of correct operation of the printer applied according to the invention are as follows:

### 1. Feeding of the Support and Working Materials.

After having fixed the device containing the working wire ( 1.78 mm) on the machine, the feeding mechanism starts, and pushes the fibre towards the already started knurled roll towarding the wire, resulting in the stopping of the rolls due to sensing the change of moment, and simultaneously stopping the feeding mechanism. The heating chamber—in basic state abt. 90° C.—is heated up to 260-300° C., depending on the material quality based on the information received from the heat-transmitter of the heating chamber, the program then starts the stepping motor, and the knurled roll fixed to the axel pushes the wire into the injector. The drop of 0.254 mm thickness appears on the nozzle at the end of the injector, respectively the polymer wire of the above-mentioned diameter, resulting from the permanent rotation of the stepping motor. After the appearance of the wire, abt. 30-40 mm is continuously pushed out of the machine, and after the stopping of the knurled roll the stepping motor makes a swing radius of abt. 3-4 grades into the opposite direction, resulting in the sucking back of the melt from the nozzle, and simultaneously decreasing the temperature of the heating chamber abt. 5-10° C. below “working temperature”.

Then the printing head cleans the given nozzle with the help of the stepping motor of X-direction by the forward-reverse movement of 10 mm, with the help of a bronze brush fixed to the machine, sweeping off the polymer wire of 0.254 mm pushed out and set. The variability of the temperature of the heating chamber according to the given material is extremely important, because the material properties of the polymer to be operating will determine the feeding, operating and feedback temperature. If resulting from any reason, for example due to the blocking (burning) of the injector feeding fails, then the stepping motor, sensing the change of power consumption resulting from the increased moment, stops the feeding and displays failure on the tastature.

### 2. Unthreading of Bearing and Working Material.

In case the injector (with the polymer fibre within) designated for backthreading was not in operation, then the program first heats up the heating chamber to the working temperature of the given material, then in basic state the stepping motor pushes out abt. 20-30 mm through the nozzle, then stopping the feeding, decreases the working temperature by 5-10° C., while the printing head is moving twice with a forward-reverse movement with the help of the above-mentioned brush and in basic state the polymer fibre is drawn back from the injector by the stepping motor. When the 1.78 mm fibre leaves the knurled roll, the stepping motor stops, resulting from sensing the decrease of power consumption (due to the formation of the mechanics). If no other command is received, it cools down the heating chamber to basic state (90° C.).

### 3. Basic State and Configuration.

After switching on, the machine heats up the machine to the working temperature of 74° C. with the help of the radiators (abt. 2×400W) and ventillators in the working space, and the machine only afterwards can be operated by additional commands. As a first step with the help of motors of X,Y,Z directions, the operation of the sensors is configured with accessing the given ranges, resp. the paralleling of the bench plane with the X-Y working plane is checked. In case the deviation is bigger than the given (0.1 mm) margin of error at the adjusting of the bench, or the paralleling of the plastic panel on the bench, then failure is indicated, and further commands are accepted only after trouble-shooting. Simultaneously with the heating up of the working space each heating chamber (together with the polymer fibre within) is heated up to the basic temperature of 90° C. mentioned earlier. The measuring of the basic state (height) is checked at eight points during the accessing of the working space of the bench, resp. comparing measurements are taken. It is possible to run a test program on the tastature or in the PC menu for periodic abt. 20 mm moving the stepping motors manually within the designated working space. Reaching the final position overrides the stepping command. It is possible to open the operating magnetic lock door until the starting of the production of the body model, but afterwards the door lock operated with a snap magnet can be opened only by stopping the operation (after cooling back the machine to 35° C.).

### 4. The Operation of the STL File Configuration Program.

The STL data of the body model recorded by any method (3D scanning, design program, CT-MRI X-ray) is visualized in the virtual working space by the program, either in millimeter, or in inch with the help of scale changing, tilting, rotating. For the final arrangement in the working space the program generates a bearing material buildup, which can be changed and is of optimum setup, and can be visualized layer by layer on basis of disassembly. The drawing of the 2D outline of the body model (with bearing material) saved this way can be shifted, multiplied, saved, deleted on the bench, then can be sent to the memory of the 3D printer for printing.

### 5.Working Process.

Printing starts in every case with the positioning of the six-eight bases made of bearing material in such a way, that the first two rows (layers) the external and-or the internal outlines are made by the printer with a continuous line, and the space between is made with putting down a special grid structure. The upper two rows are made with continuous hatching in such a way, that the direction of the hatching of the two rows angles 90 degrees with each other. Then the printing head “goes out” behind the line of the brushes, and the head changes to the working material nozzles, with the help of the operating rods, and the bumpers placed in the working space. The program will choose the working fibre to operate with the help of the pixels of STL data distinguished on the single layers. The same principle is used when choosing the heating chamber of the three working fibres to be pre-heated below 5-10° C. of the working temperature characteristic of the fibre. “Pre-heating” is necessary to prevent unwanted fibre production from the nozzles in repose, because it could be polymerized into the working piece when released above the working space, causing aesthetic defect.

Obviously the control can only start the designated nozzle above the slice, if it is heated back to the working temperature, a fibre of abt. 5-10 mm was pushed out, the feeding motor stopped, then “before starting to work it brushed off forward-reverse”. The designation can be influenced by the fact, that the internal parts of the working space must be first placed, in order to prevent the other nozzle working at the same level “to bump into” the ready surface. In the case, when only the support and one working fibre work within the slice, then it can be allowed, that two rows with both fibres are made simultaneously. In case two or three working fibres work, then it is preferable to make only one slice at a time, resulting in the increase of the time of production.

Making of the “designated” area always starts with the outlining of the delineation by the working fibre, then the area is “hatched” in 45 degrees with the command of the stepping motors. If it bumps into an internal outline when hatching,—eg. a bore—, then the area behind the bore can be reached by a new approach only. Each “change of approach” occurs with the downward movement of 1-1.5 mm of the bench. It seems preferable to make control measuring in eg. each 20 rows on the ready piece and compare it with the height measurements of the slice of similar number of the configuration file, then correct it as needed with the elevations(s) of the bench. In case of a preferable application (even if not as a first step) disassembly can be made variable during the process, because this way the bodies of more complicated surfaces can be made a living image with finer details. In case the program must be interrupted (pauza) then at restarting the pixel within the slice must be precisely found. During a preferable application the printer is capable of doing the same. (uninterruptible power supply).

In case of the most common application of the method according to the invention, the patient's oral cavity is mapped or scanned by a known method, and converted into digital data. The digital, virtual image, model of the oral cavity is created from these data. The digital plan of the dental prosthesis, of tooth replacement is designed in this digital model. The database needed for the spatial printing is established from this digital plan.

The prosthesis is produced with a spatial printer suitable for printing different colors, different raw materials from the digital model made with the known method, from thermoplastic material with a process based on melt layering, Fused Deposition Modelling, (FDM), or Multi Jet Modelling (MJM). A plastic prosthesis with suitable mechanical and biological parameters is produced this way, the coloring and anatomical form fully conform with the teeth in the normal oral cavity and perfectly fit to the adequate parts of the oral cavity.

An important feature of the solution according to the invention is, what kind of way, respectively by which method the finished product, the prosthesis with individual characteristics is produced. Though there are several known methods for scanning digitally an oral cavity, respectively designing digitally a prosthesis, but it is not the same how it is ultimately realized. Prostheses built in different ways, with milling, or with other methods will work in different ways as mechanical units. In our opinion the method of production makes a difference. We found, that production based on melt layering from a thermoplastic material suits best all the mechanical and anatomical requirements of prostheses.

We realized that the mechanical parameters—loadbearing capability, flexibility—of a prothesis built in such way are better, than if it had been made in a different way. All in all it is easier and less expensive to produce a prosthesis this way, than with another methods, like eg. milling.

When produced by milling, material loss is for example quite big, on top of that the useful material (the material of the denture) is being milled, which is expensive. In case of other building methods the prosthesis can not be properly realized, eg. due to the limits of building resulting from the shape of the prosthesis, or the mechanical properties of the denture will not be good enough. An additional drawback of making prostheses by milling is that it makes possible the use of one color only, and this must be painted, colored afterwards.

In case of prostheses it is furthermore very important to consider additional anatomical, aesthetical aspects. The prosthesis must be perfect from anatomical point of view, otherwise is can not be used, respectively it comes with the feeling of discomfort. From aesthetical point of view it has to meet certain special requirements, eg. the gum must be pink, the tooth must be white, but it is not all the same what tone the whiteness of the tooth is (darker on the lower part, lighter on the upper part). Prostheses produced from thermoplastic material with a technology based on melt layering, Fused Deposition Modelling (FDM) technology, or Multi Jet Modelling (MJM) technology conformed fully to the above-mentioned requirements.

According to the above an important part of the invention is the method itself, with which, or how the prosthesis designed digitally is made, as well as the prosthesis itself, that is made this way. Consequently the essence of the solution is eventually the way of the production, and this constitutes the subject of the invention. Making the digital plan and mapping the oral cavity are considered as advantageous, preferable application of known procedures only.

The equipment used for the production is also important, respectively the forming of the extruder head. Apropos of this the fact, that instead of one double head, two double adjacent heads are placed, moving together, resulting in a considerable advantage in itself in case of the production of multicolor prostheses of special anatomical form. This advantage shows rather in the production process, during which such equipment is used. The application of two double heads at the production of prosthesis helps the creation, makes possible the realization of the prosthesis of the proper anatomical form, coloring, mechanical parameters.

There are other good methods for making prostheses, respectively the way how to plan prostheses digitally, and also how to realize it by spatial printing. However it is not obvious, what we can expect from certain prostheses realized with certain spatial printing, respectively which method is, that is suitable for making a prosthesis in the given individual case with appropriate properties.

As per the realization according to the invention in case we have an oral cavity mapped in some way digitally, and a prosthesis designed into it in the known ways, then on basis of this the model realized the best way is the one, that was made from different colors, from a thermoplastic material with a technology based on melt layering, Fused Deposition Modelling, (FDM) or Multi Jet Modelling (MJM), respectively with equipment suitable for it.

In case of a preferable application of the solution according to the invention the prosthesis is made from a material polymerizing under light. The 3D printer PRI used can have two heads, or four heads. From the point of view of the finished prosthesis PRO it is important, that only biocompatible materials, suitable in dentistry are used, which can be safely put into the oral cavity.

The setting of the material in the 3D printer PRI occurs under light, which is the light of a special LED light, on a given wavelength and with intensity required by the material applied. This way the head of the 3D printer PRI builds up the model layer by layer, and at the end of the procedure the completely ready prosthesis PRO comes, that can be put into the mouth.

Practically no afterwork is needed depending on the applied 3D printer PRI technology and materials applied. In case of applying certain materials the finished prosthesis PRO should be given a final polymerization, which is a lighting of a certain period, or treating. Furthermore the finished prothesis PRO should be provided with a polymer coating of high gloss, which is a polymer layer (vanish) setting under light, it hardens on the effect of light and creates a glossy external layer.

In case of a preferable application the lower and upper prosthesis are made as separate pieces, but at the same time. Partial dentures can be made as well, when retention is provided with a gum clamp by the program, which is also made of plastic. Designing this time should be executed by a suitable software, that can plan a gum clamp as well.

### Conditions of Further Applications:

### Digital Model Planning:

The digital model planning software calculates on basis of an anatomical model what the patient's teeth used to be like, designs the prosthesis accordingly, that is
fills in the oral cavity, the teeth for the oral cavity mold taken,
during which the base plate is made, onto which the teeth are built,
the 3D printer builds up the teeth from white tooth-like color material, the base plate from monochrom pink color (gingiva), therefore multicolor 3D printer is needed.

Conditions regarding 3D printer:
It should be multicolor, capable of using two-three-four colors, not monochrome.
It should be capable of working with biocompatible materials.
It should be capable of using liquid composite material setting under light.

During the possible application of the method according to the invention digital data are taken from the patient's oral cavity with a suitable mouth-scanner in a dentistry. It is also possible to use numerous scanners, and a few software terminals and 3D printer are sufficient, because then they are efficient. Data recording takes place with the scanner and input of other information takes about two-three minutes. Then production of the digital model of the prosthesis is a task of some minutes. Printing takes a few hours, so the patient can get their new prosthesis the same, or the next day. With the help of a suitable software the whole work procedure can be executed by a single, well trained dental assistent.

The conditions of the preferable concrete realization of the method according to the invention are:
For the application of the method according to the invention such equipment is suitable from among the known 3D methods, that is capable for producing lower or upper denture for prosthetic dentistry of two (three) color and/or material quality on basis of a digitalized input. Resulting from the in the state of the art techniques only systems like FDM, or Objet-PoliJet are capable for working with several components. Objet-PoliJet system is currently able to work with polymers of two different qualities at the same time, but only then, if the formation of the body to be produced does not require a socalled bearing material.

The Requirements of the Choice of the Machine (technology):
The prosthesis to be produced however requires the use of a bearing material resulting from its type, therefore the actual working space must be divided in case of the Objet system to make it suitable for working with two different types of polymers with keeping the bearing material. Due to the complexity of the necessary modifications and due to its cost- and time-consuming nature the choice must be limited to FDM technology. The machine should be modified in the knowledge of the measurements of the piece to be produced and the measurements of the bench according to the requirements. The most important element of the modification is the extra piece of extruder head to be built in.

### The Tasks to be Solved During Modification:

Designing the software of the input side.

The program created should ensure all three input side conditions, in case of an X-ray image characteristic points of the mucous membranes as well as those of the lower-upper gums, must be taken into consideration, it must be parametric and “self-teaching” and must have an STL output for the machine's own software.

Mechanics modification, designing of new cover, image.

Installing a second extruder head into the x axel of the available 3D mechanics mentioned at the aspects of choosing, should be uniaxial, pixels should be adjustable. New raw material—installing reels for wire holding, as well as designing, installing new wire forwarding mechanism. Planning, production, assembly of new support structure, of cover, fixing of computer with touch-screen into the front panel, forming of a control platform.

Replanning of machine software.

Extruder head with wire moving.

With the installment of a new extruder head synchronized operation of the two heads independently from each other in the “sliced” planes must be ensured. Possibility must be given for choosing the “route” and the possible wall thickness.

Replanning of the control panel.

On basis of the new machine software planning of a panel of printed circuit according to the new circuit diagram, choosing microelectronic devices, installing into the mucous plane, fixing, operating with 3D executing units, resp. with extruder heaters, thermal stabilization of the working space.

### The Advantages of the Solution According to the Invention:

With the help of the method different prostheses can be produced in a short time in individual sizes, in great numbers, and the time of production is considerably shortened. It makes the dental technician's work easier, unnecessary. It makes the dentist's work easier as well.

The method of producing removable dentures changes, as the traditional, complicated prosthetic devices are not needed.

The tooth replacement according to the invention can be applied for building up of multicolor dentures of a fixed tooth replacement, not only for production of removable prostheses.

### LIST OF REFERENCES

SC—3D scanner
PC—computer
PRI—3D printer
M—model
PRO—prosthesis
1—melt
2—start of setting
3—set state
4—head
5—model
6—feed drum
7—bench
8—raw material
10—3D printer
11—multifunctional head unit (containing four printing heads)
12—printing head
13—bench
14—elevating spindle (for bench)
15—vertical guide rails (for bench)
16—horizontal guide rail (for head unit forward-backward
17—horizontal guide rail (for head unit, lateral right left)
18—operating and control panel
20—discharge opening
21—support panel
22—bearing material
23—raw material for the prosthesis base plate
24—raw material a for tooth color 1 eg. for toothneck
25—raw material a for tooth color 2 eg. for toothedge

1. Method to create removable dental prosthesis, during which a digital data recording is made of the oral cavity without teeth, or with partial teeth-deficieny, or of the model taken of it, then the information received this way is processed by a computer with the help of a targeted software, and the virtual digital image of the removable tooth replacement (prosthesis) is created,
and on basis of the virtual digital image of the prosthesis the finished product of the prosthesis itself, the base plate and the teeth are made with the help of a prototype making equipment of unique model-building,
characterized by that,
the prosthesis is produced from the established digital model with a spatial 3D printer (PRI) suitable for printing several different colors, several different raw materials from a thermoplastic raw material with a method based on melt layering, preferably with a Fused Deposition Modelling, (FDM) method.

2. Method to create removable dental prosthesis, during which a digital data recording is made of the oral cavity without teeth, or with partial teeth-deficieny, or of the model taken of it, then the information received this way is processed by a computer with the help of a targeted software, and the virtual digital image of the removable tooth replacement (prosthesis) is created,
and on basis of the virtual digital image of the prosthesis the finished product of the prosthesis itself, the base plate and the teeth are made with the help of a prototype making equipment of unique model-building,
characterized by that,
the prosthesis is produced from the established digital model with a spatial 3D printer (PRI) suitable for printing several different colors, several different raw materials from a biologically compatible liquid composite plastic material setting under laser or UV light, preferably with Multi Jet Modelling (MJM) method.

3. Method according to claim 2, characterized by that, the material used during the making of the prosthesis (PRO) is a biologically compatible, liquid composite, setting under light, typically plastic polymer which can form to spatial netted structure setting under laser or UV light.

4. Method according to claim 1, characterized by that, digital data recording takes place either directly from the mouth in the oral cavity, or from a mold made of the mouth, respectively from the model made on basis of the mold, with applying 3D scanner.

5. Method according to claim 1, characterized by that, the digital data recording takes place either on basis of a 3D CT X-ray, or a 3D X-ray, or on basis of an MRI recording.

6. Method according to claim 1, characterized by that, following the digital data recording certain additional information is acquired regarding the position (articulation) of the mandible (mandibula) respectively the upper jaw (maxilla) and the virtual digital image of the removable teeth replacement (prosthesis) is corrected by these data.

7. Method according to claim 1, characterized by that, during the method the steps of the task to be realized are the following:
Receiving X-ray recording made by an external device (3D Scanner, 3D CT, MRI),
Conversion of database received this way into proper format (optional),
Disassembly input data into layers, separating of “materials” of different types,
Creating automatic mucous membrane on basis of input materials,
Saving body model consisting of several layers for further use,
Visualizing layers as a 3D model,
Editing certain parts of the model, executing different modifications on basis of parameters determined later,
Making layer by layer STL database from the body model prepared this way,
Sending STL database made to the printer,
Continuous communication with the printer (handling mistakes)
Installing copy protection function, joining the hardware of the printer.

8. Method according to claim 1, characterized by that, the temperature of the work space of the 3D printer (PRI) used in the method, can be regulated and stabilized.

9. Method according to claim 1, characterized by that, reading of STL files into the device and preparing spatial printing take place with the production control software of 3D printer, with the help of “Software 3” program package.

10. Method according to claim 1, characterized by that, the definite operation of the 3D printer (PRI) applied during the method, its hardware elements, for example head warming, material feeding, bench moving, fibre feeding, syncronous motors, as well as the regulation of the several heads are controlled by a target software, in given case “Software 4” designated for this purpose.

11. Method according to claim 1, characterized by that, the 3D printer (PRI) applied uses a bearing material, and biocompatible raw material of two or three or four color, and the 3D printer (PRI) builds up the teeth from a white, toothlike color material, the base plate is made from a unicolor pink material (gingiva).

12. Method according to claim 1, characterized by that, the 3D printer (PRI) operating on melting principle (FDM) includes a head unit suitable for feeding four different materials.

13. Method according to claim 1, characterized by that, the head unit applied during the method comprises two adjacent double heads (4) moving independently from each other, but synchronized with each other, which are heated FDM heads (4) functioning on mini-extruder principle, and the moving of high-speed 3D is controlled by a CAD/CAM program.

14. Method according to claim 1, characterized by that, in case a partially removable denture is made, then retention is provided with a gum-clamp or tooth-clamp by the program, which must be designed by such a program for this purpose, that is capable of making gum-clamp and tooth-clamp.

15. Method according to claim 1, characterized by that, a complete prosthesis, a lower and upper denture fitting to each other is made.

16. Method according to claim 1, characterized by that, the application of the method takes place on a local level, in given case with the participation of a dental expert, using a 3D scanner (SC), a computer (PC), and a 3D printer (PRI).

17. Method according to claim 1, characterized by that, the application of certain steps of the method takes place on different locations, and for the application of the first step scanners and/or CT terminals are installed on different spots, the data of which are sent to a central place, to a central computer, where designing of the prosthesis (PRO) with the targeted software as the second step occurs, and as a third step, the production takes place on the same spot, from where in given case delivery takes place with a mail delivery service or a courier.

18. Method according to claim 1, characterized by that, the patients themselves make the prosthesis (PRO), respectively with the help of a mouth scanner they themselves take the mold.

19. Dental prosthesis, characterized by that, it is primarily made, using the method according to claim 1.

20. Dental prosthesis according to claim 19, characterized by that, the prosthesis is made with melting process (FDM) using bearing material and raw materials of several colors applied layer by layer within a production process.
